(19) United States
(12) Patent Application Publication
(10) Pub. No.: US 2025/0124690 A1
(43) Pub. Date: Apr. 17, 2025

(54) SMART VENDING MACHINE SYSTEM

(71) Applicant: Crane Payment Innovations, Inc., Malvern, PA (US)

(72) Inventor: Dmytro Baydin, Glenmoore, PA (US)

(21) Appl. No.: 18/692,436

(22) PCT Filed: Nov. 16, 2022
(86) PCT No.: PCT/US2022/079986

§ 371 Date: Mar. 15, 2024

Related U.S. Application Data
(60) Provisional application No. 63/284,332, filed on Nov. 30, 2021.

(51) Int. Cl. G06V 10/774; G06Q 10/087; G06V 10/764

(52) U.S. Cl. CPC G06V 10/774; G06Q 10/087; G06V 10/764; G06V 2201/06

(57) ABSTRACT

A system comprises a processor, a memory, a vending machine, at least one imaging sensor, and an active feedback system. The processor is configured to switch the vending machine to a training mode, detect, using the at least one imaging sensor, an object, capture, using the at least one imaging sensor, one or more images of the object, provide, using the active feedback system, feedback based on the one or more captured images of the object regarding a different view, capture, using the at least one imaging sensor, at least one next image of the object, generate a training set of images from at least a portion of the captured images, and train a machine learning model using the training set of images to update the machine learning model to recognize the object.

### CROSS-REFERENCE TO RELATED APPLICATIONS

This application is a 371 National Stage of International Application No. PCT/US2022/079986, filed Nov. 16, 2022, which claims priority to U.S. Provisional Patent Application No. 63/284,332, filed Nov. 30, 2021, the disclosures of which are incorporated herein by reference in their entirety.

### TECHNICAL FIELD

This disclosure relates generally to vending systems. More specifically, this disclosure relates to a smart vending machine system.

### BACKGROUND

Existing vending machines and associated systems experience problems with the introduction of new products. Systems based on image recognition requires a representative set of object images in order to be trained for the object recognition. Methods for providing the representative set of object images have drawbacks, however. For example, an operator of the vending machine can send samples of the product to the manufacturer of the machine to make pictures or videos of the object and train the system, but this takes time and considerable logistics. As another example, an operator can make pictures or videos and send them to the manufacturer, but this is not a robust process since without timely feedback the operator might not be able to create proper representative data, resulting in weak system performance.

### SUMMARY

This disclosure provides a smart vending machine system.

In one aspect, a method of adding a new product into a camera-based vending machine includes entering by an operator the camera-based vending machine into new product addition mode, holding by the operator the new product in at least one of her/his hands, presenting by the operator the new product in front of a camera in the camera-based vending machine, taking, by the camera, a picture of the new product held by the operator in at least one of her/his hands, providing feedback to the operator to take a next picture of the new product in a different view to complete the training set of images for the new product, indicating to the operator that sufficient views of the new product have been gathered, updating a product recognition algorithm to recognize the new product, and adding the new product into the camera-based vending machine.

In some embodiments, the product recognition algorithm is updated to recognize the new product after a pre-determined delay.

In some embodiments, the product recognition algorithm is updated in a remote computer.

In some embodiments, the product recognition algorithm is updated in a local computer.

In some embodiments, feedback to operator is provided by a screen.

In some embodiments, feedback to operator is provided by a LED.

In another aspect, a new product onboarding system for a camera-based vending machine without a dispensing system comprises an enclosed space with space to store products inside the camera-based vending machine without a dispensing system, at least a camera to take multiple pictures of product taken out by a customer, a processing unit to identify products from at least a picture, the camera to capture images of a new product to be added to the camera-based vending machine without a dispensing system where the product is held in an operator's hand, an active feedback system to instruct the operator to present different views of the new product held in operator's hand, the active feedback system to inform the operator that sufficient views of the new product have been gathered, and the processing unit to update a product recognition algorithm to recognize the new product.

In some embodiments, the product recognition algorithm is updated to recognize the new product after a pre-determined delay.

In some embodiments, the processing unit to update the product recognition algorithm is located remotely.

In some embodiments, the processing unit to update the product recognition algorithm is located in a local computer.

In some embodiments, a screen provides feedback to operator.

In some embodiments, a LED provides feedback to operator.

In another aspect, a method of adding a new product into a camera-based vending machine comprises entering by an operator the camera-based vending machine into new product addition mode, placing by the operator the new product in a new product add location in the camera-based vending machine, taking, by the camera, a picture of the new product placed in the new product add location by the operator, providing feedback to the operator to take a next picture of the new product in a different view to complete the training set of images for the new product, indicating to the operator that sufficient views of the new product have been gathered, updating a product recognition algorithm to recognize the new product, and adding the new product into the camera-based vending machine.

In some embodiments, the product recognition algorithm is updated to recognize the new product after a pre-determined delay.

In some embodiments, the product recognition algorithm is updated in a remote computer.

In some embodiments, the product recognition algorithm is updated in a local computer.

In some embodiments, feedback to operator is provided by a screen.

In some embodiments, feedback to operator is provided by a LED.

In another aspect, a new product onboarding system for a camera-based vending machine without a dispensing system comprises an enclosed space with space to store products inside the camera-based vending machine without a dispensing system, at least a camera to take multiple pictures of product taken out by a customer, a processing unit to identify products from at least a picture, the camera to capture images of a new product to be added to the camera-based vending machine without a dispensing system where the product is placed in a new product add location in the camera-based vending machine, an active feedback system to instruct the operator to present different views of the new product placed in the new product add location in the camera-based vending machine, the active feedback system to inform the operator that sufficient views of the new product have been gathered, and the processing unit to update a product recognition algorithm to recognize the new product.

In some embodiments, the product recognition algorithm is updated to recognize the new product after a pre-determined delay.

In some embodiments, the processing unit to update the product recognition algorithm is located remotely.

In some embodiments, the processing unit to update the product recognition algorithm is located in a local computer.

In some embodiments, a screen provides feedback to operator.

In some embodiments, a LED provides feedback to operator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), electrically erasable programmable read only memory (EEPROM/E2PROM), random access memory (RAM), ferroelectric RAM (FRAM), a hard disk drive, a compact disc (CD), a digital video disc (DVD), or any other type of volatile/non-volatile/memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with embodiments of this disclosure;

FIG. 2 illustrates one example of a smart vending machine in accordance with embodiments of this disclosure;

FIG. 3 illustrates an example smart vending machine system in accordance with embodiments of this disclosure;

FIG. 4 illustrates an example smart vending machine transaction method in accordance with embodiments of this disclosure;

FIG. 5 illustrates an example smart vending machine system in accordance with embodiments of this disclosure;

FIG. 6 illustrates an example pre-payment transaction method in accordance with embodiments of this disclosure;

FIG. 7 illustrates a post-payment transaction method in accordance with embodiments of this disclosure;

FIG. 8 illustrates an example new product recognition process in accordance with embodiments of this disclosure;

FIG. 9 illustrates a new object recognition method in accordance with embodiments of this disclosure; and

FIG. 10 illustrates an example electronic device in accordance with embodiments of this disclosure.

### DETAILED DESCRIPTION

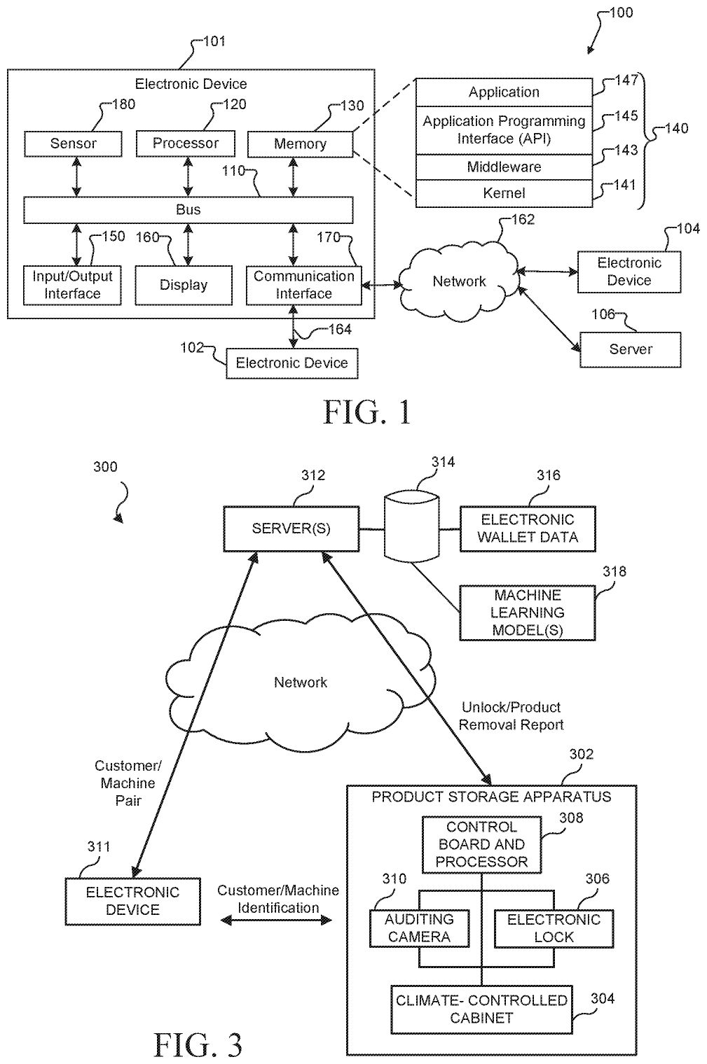

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, coin, coinage, and cash may be used interchangeably herein to refer to a type of a negotiable instrument or any other writing that evidences a right to the payment of a monetary obligation, typically issued by a central banking authority.

As noted above, existing vending machines and associated systems experience problems with the introduction of new products. Systems based on image recognition requires a representative set of object images in order to be trained for the object recognition. Methods for providing the representative set of object images have drawbacks, however. For example, an operator of the vending machine can send samples of the product to the manufacturer of the machine to make pictures or videos of the object and train the system, but this takes time and considerable logistics. As another example, an operator can make pictures or videos and send them to the manufacturer, but this is not a robust process since without timely feedback the operator might not be able to create proper representative data, resulting in weak system performance.

The smart vending machine system of the various embodiments of this disclosure provides a vending machine or cooler with an electronic lock and one or more imaging devices or sensors. In some embodiments of this disclosure, the smart vending machine or cooler can interact with a customer via an electronic device associated with the customer to receive selected product and purchase information, receive validation, such as from one or more servers, that the customer has sufficient funds for the purchase, unlock the vending machine based on the validation from the server(s), update inventory auditing information based on the purchase and on a product being removed, and update or create and send transaction reports to the server(s).

In embodiments of this disclosure, the vending machine or cooler includes one or more imaging devices such as one or more auditing cameras that captures images of an interior of the vending machine for use in auditing inventory remaining in the vending machine. Additionally, the one or more imaging devices can be used during machine learning training processes to provide images of new products to be used as sample training data to train machine learning models stored within a memory of the vending machine or stored in association with the vending machine, such as at one or more servers. During image capture of the new product, the vending machine or cooler can analyze captured images to determine whether the images are fit to use as training samples, and, if not, can provide instructions to operator(s) to adjust the manner in which the product for the training images is being presented to the one or more imaging devices.

FIG. 1 illustrates an example network configuration 100 including an electronic device in accordance with embodiments of this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. In various embodiments, the electronic device 101 can be a smart vending machine or cooler, and/or an electronic device associated with a user, e.g., a customer, or an operator, such as a smartphone device or other type of electronic device described in this disclosure. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described below, the processor 120 may receive and process inputs (such as image inputs or data received from an imaging device) and perform machine learning model training using the image inputs as training data. The processor 120 may also instruct other devices to perform certain operations (such as outputting audio using an audio output device like a speaker) or display content on one or more displays 160. The processor 120 may further receive inputs regarding product purchases, including product information, payment information, locking/unlocking commands, etc.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 includes one or more applications supporting the receipt of image data and using the image data to train one or more machine learning models, outputting audio, video, images, or other content, processing product purchases, processing locking/unlocking commands, auditing inventory, creating audit or transaction reports, etc. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The electronic device 101 further includes one or more sensors 180 that can meter a physical quantity or detect an activation state of the electronic device 101 and convert metered or detected information into an electrical signal. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may receive and process inputs (such as image inputs or data received from an imaging device) and perform machine learning model training using the image inputs as training data. The server 106 may also instruct other devices to perform certain operations (such as outputting audio using an audio output device like a speaker) or display content on one or more displays 160. The server 106 may further receive inputs regarding product purchases, including product information or payment information, transmit product purchase confirmations, transmit locking/unlocking commands, receive audit and/or transaction reports, etc.

Although FIG. 1 illustrates one example of a network configuration 100 including an electronic device 101, various changes may be made to FIG. 1. For example, the network configuration 100 could include any suitable number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

The smart vending machine system of embodiments of this disclosure includes a smart vending machine or cooler that includes a cabinet for storing products. In various embodiments, the cabinet includes an electronic lock, at least one product auditing image device, e.g., a camera, product auditing and/or image recognition models or algorithms, and a control board including at least a processor, a memory, and one or more network interfaces as described, for example, with respect to FIG. 1 or FIG. 10.

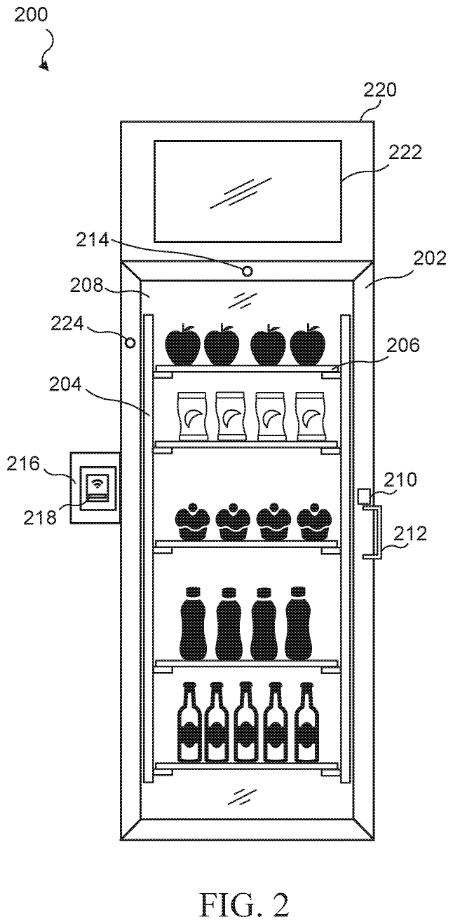

For example, FIG. 2 illustrates one example of a smart vending machine 200 in accordance with embodiments of this disclosure. For ease of explanation, the smart vending machine 200 is described as involving the use of the electronic device 101 in the network configuration 100 of FIG. 1, and the smart vending machine 200 can be, or incorporate components of, electronic device 101. Vending machines come in a wide variety of configurations, and FIG. 2 does not limit the scope of this disclosure to any particular implementation a vending machine.

In some embodiments, the smart vending machine 200 is a cooler or refrigeration device that includes a cabinet comprising a door 202 and a shelving system 204 including a plurality of shelves 206 for holding a plurality of products of various product types. The door can include a window 208 made of glass, plastic, or other transparent material that allows for customer to view the products stored on the shelves 206. The door 202 of the smart vending machine 200 can lock or unlock via an electronic lock 210 when a customer decides to make a purchase, allowing the customer to open the door 202 of the cabinet and retrieve one or more products. In some embodiments, the electronic lock 210 engages or disengages a locking mechanism associated with a handle 212 coupled to the door 202. In some embodiments, the electronic lock 210 can engage or disengage a locking mechanism integrated between the door 202 and a portion of the cabinet that holds the door secured against the cabinet such as when a customer pulls on the handle 212.

The smart vending machine 200 includes one or more imaging devices 214. In some embodiments, product auditing and/or image recognition models or algorithms are included in a memory of the smart vending machine 200. In some embodiments, the product auditing and/or image recognition models or algorithms are stored in a cloud server(s), with the smart vending machine 200 providing images, using the one or more imaging devices 214, to a cloud server for processing and/or auditing. In various embodiments, the server(s) controls the locking/unlocking of the electronic lock 210 as well as receiving product removal reports from the smart vending machine, in addition to other functions. The smart vending machine 200 can communicate with the cloud server via the one or more network interfaces, such as communication interface 170, and the smart vending machine and cloud server can be coupled via a wired or wireless network connection over a network such as a wide area network (WAN) or the Internet.

The smart vending machine 200 also includes a payment interface 216. In various embodiments, the payment interface 216 can include physical payment interfaces such as a card swipe or slot 218, wireless payment interfaces, or both. For example, in embodiments of this disclosure, a customer mobile device such as a smartphone or other device can communicate with the smart vending machine wirelessly, such as via a BLUETOOTH connection or other wireless connection, to perform transactions such as purchasing products from the vending machine 200. The mobile device can include a mobile application configured to communicate with both the smart vending machine to establish customer and machine identifications, and with the cloud server to provide the customer and machine identifications, as well as to facilitate payment for products. In some embodiments, an operator can use a similar mobile device executing an application to similarly communicate with the smart vending machine to, for example, add new products to the smart vending machine via a new product training process described in the various embodiments of this disclosure.

Various funding sources can be used to facilitate payment by a customer for a product stored within the smart vending machine. For example, in various embodiments, the server(s) stores credit, debit, or ePayment information and a pre-authorization that is associated with a user. A pre-authorization for a transaction is made before the smart vending machine is unlocked, and settlement is made once a product has been removed and the door is locked. In some embodiments, an electronic wallet can be associated with each customer account and stored at, or in association with, the cloud server. The aforementioned credit, debit, or ePayment information can be used by a customer to manually add funds to the wallet, or the system can be configured, such as in accordance with customer preferences or settings, to automatically add funds to the wallet, such as if the value of the products removed exceeds the amount stored in the wallet, or if the funds in the wallet fall below a threshold. In some embodiments, a third-party wallet-type system can be used, such as GOOGLE PAY, to fund a transaction from the mobile application on the mobile device, and a transaction success status is sent to the cloud server to trigger unlocking of the cabinet, or dispensing of a product in some embodiments. In some embodiments, a paper coupon can be scanned by the mobile application to facilitate payment, or an electronic coupon can be stored in the cloud that can be redeemed for a product.

In various embodiments of this disclosure, the one or more imaging devices 214 can be one or more image capture devices such as a still image capture device or video camera device. In some embodiments, such as illustrated in FIG. 2, one or more image capture devices 214 can be installed on an exterior portion of the chassis of the vending machine, and positioned to view through a front window of the vending machine into the internal compartment to capture images of the interior of the vending machine, as well as to view external area of the vending machine during new product processes. In some embodiments, an operator can use an image capture device, such as a handheld camera and/or a smartphone device, to capture images of products within the smart vending machine, or images of new products to be added to the smart vending machine system. In some embodiments, the system includes two or more image capture devices that capture video of products moving in and/or out of the machine to maintain accurate product inventory information. In some embodiments, image capture devices can be placed in areas where products on shelves are seen, such as placed to view through a window of the cabinet, or when cameras are placed inside the cabinet. In such embodiments, before and after images of products in the cabinet can be captured, that is, before a customer removes products and after a customer removes products.

In some embodiments, the smart vending machine 200 can also include a display portion 220 including a display 222. The display portion 220 can be located at a top portion of the vending machine 200 as illustrated in FIG. 2, but could be located at another location in other embodiments. In some embodiments, the display 222 is a digital display, such as display 160, that can display advertisements or other information to customers. In some embodiments, the display screen 222 provides, as at least part of an active feedback system, information to operators of the vending machine 200 such as machine learning training instructions. In some embodiments, the vending machine 200 includes an indicator 224, such as an LED, which can be at least a part of the active feedback system, including in conjunction with the display 222. In some embodiments, instead of providing messages on a display, the smart vending machine includes the indicator 224 such as an LED that remains red as more images are needed, and switches to green when enough images have been received. In some embodiments, the display 222 is a static display such as a physical image that could be configured to show various information, such as a logo of the owner of the vending machine 200, a logo of a store in which the vending machine 200 is located, product information for products in the vending machine 200, and/or instructions for customers on how to provide payment to purchase products from the vending machine 200.

Although FIG. 2 illustrates one example of a smart vending machine 200, various changes may be made to FIG. 2. For example, the imaging sensors 214 illustrated in FIG. 2 can be located on an outside portion of the cabinet as shown in FIG. 2, within the climate-controlled interior of the cabinet, or both, to perform image capture of objects outside the vending machine (users, training products, etc.) and inside the vending machine (products for inventory auditing, etc.). For instance, in various embodiments, the image capture device 214 is mounted or otherwise placed in a location in proximity to the smart vending machine such that the image capture device can capture images of the vending machine, particularly an internal portion of the cabinet, housing, or chassis where products are stored, as well as externally during a training mode in which new products are added to the smart vending machine system. The one or more image capture devices 214 can also or alternatively be placed within the internal compartment of the vending machine to capture images of the interior of the vending machine. In some embodiments, the smart vending machine can be a vending machine with a product dispensing mechanism without departing from the scope of this disclosure. In some embodiments, the vending machine 200 does not include the window 208, such that products are not seen through the door, such as if the cameras cannot view through the door of the cabinet. In such embodiments, the image capture devices may attempt to capture images of products in a customer's hands as the customer removes the product(s). In such embodiments, before and after images can be captured during the time in which the cabinet door is opened.

FIG. 3 illustrates an example smart vending machine system 300 in accordance with various embodiments of this disclosure. Vending machine systems come in a wide variety of configurations, and FIG. 3 does not limit the scope of this disclosure to any particular implementation of an automated payment system. For ease of explanation, the system 300 is described as involving the use of one or more electronic devices 101 (e.g., vending machine 200) in the network configuration 100 of FIG. 1. However, the system 300 may be used with any other suitable electronic device (such as the server 106) or a combination of devices (such as the electronic device 101 and the server 106) and in any other suitable system(s).

In some embodiments, the system 300 includes a smart vending machine that is a cooler or refrigeration device 302, such as the vending machine 200, including a climate-controlled cabinet 304 that unlocks via an electronic lock 306, such as when a customer decides to make a purchase, allowing the customer to open a door of the cabinet 304 and retrieve one or more products. In some embodiments, the smart vending machine 302 can be a vending machine with a product dispensing mechanism without departing from the scope of this disclosure. In some embodiments, product auditing and/or image recognition models 318 or algorithms are included in a memory of the smart vending machine 302, such as memory coupled to a control board and processor 308, such as the memory 130, and processor 120, described with respect to FIG. 1. In some embodiments, the product auditing and/or image recognition models or algorithms 318 are stored in a cloud server(s) 312, with the smart vending machine providing images to a cloud server for processing and/or auditing using one or more imaging devices such as at least one auditing camera 310 disposed on or within the vending machine 302 and coupled to the control board and processor 308. The system 300 further includes the cloud server 312, which, in various embodiments, controls the locking/unlocking of the electronic lock 306 as well as receiving product removal reports from the smart vending machine 302, in addition to other functions. The smart vending machine 302 can communicate with the cloud server 312 via one or more network interfaces, such as communication interface 170, and the smart vending machine 302 and cloud server 312 can be coupled via a wired or wireless network connection over a network such as a WAN or the Internet.

The system 300 also includes a customer mobile device 311 such as a smartphone or other device that communicates with the smart vending machine 302 in various ways, such as via a wireless connection such as a BLUETOOTH connection. In some embodiments, an operator can use a similar mobile device 311 to similarly communicate with the smart vending machine 302 to, for example, add new products to the smart vending machine 302 via a product addition and recognition process described in the various embodiments of this disclosure. The mobile device 311 can include a mobile application configured to communicate with both the smart vending machine to establish customer and machine identifications, and with the cloud server 312 to provide the customer and machine identifications, as well as to facilitate payment for products.

Various funding sources can be used to facilitate payment by a customer for a product stored within the smart vending machine 302. For example, in various embodiments, the cloud server 312 stores, in a datastore 314, one or more of credit, debit, or ePayment information and a pre-authorization that is associated with a user. A pre-authorization for a transaction is made before the smart vending machine 302 is unlocked, and settlement is made once a product has been removed and the door is locked. In some embodiments, an electronic wallet 316 can be associated with each customer account and stored at, or in association with, the cloud server 312. The aforementioned credit, debit, or ePayment information can be used by a customer to manually add funds to the wallet, or the system 300 can be configured, such as in accordance with customer preferences or settings, to automatically add funds to the wallet, such as if the value of the products removed exceeds the amount stored in the wallet, or if the funds in the wallet falls below a threshold. In some embodiments, a third-party wallet-type system can be used, such as GOOGLE PAY, to fund a transaction from the mobile application on the mobile device, and a transaction success status is sent to the cloud server 312 to trigger unlocking of the cabinet 304 of the vending machine 302, or dispensing of a product in some embodiments. In some embodiments, a paper coupon can be scanned by the mobile application to facilitate payment, or an electronic coupon can be stored in the cloud that can be redeemed for a product.

In various embodiments of this disclosure, the product auditing camera 310 can be one or more image capture devices such as a still image device or video camera device. In some embodiments, the image capture device is mounted or otherwise placed in a location in proximity to the smart vending machine 302 such that the image capture device 310 can capture images of the vending machine 302, particularly an internal portion of the cabinet 304, housing, or chassis where products are stored, as well as externally during a training mode in which new products are added to the smart vending machine system 300. In some embodiments, one or more image capture devices 310 can be placed within the internal compartment of the vending machine to capture images of the interior of the vending machine 302. In some embodiments, one or more image capture devices 310 can be installed on an exterior portion of the chassis of the vending machine, and positioned to view through a front window of the vending machine 302 into the internal compartment to capture images of the interior of the vending machine 302, as well as to view an external area of the vending machine during new product recognition and training processes. In some embodiments, an operator can use an image capture device 310, such as a handheld camera and/or a smartphone device, such as the electronic device 311, to capture images of products within the smart vending machine, or new products to be added to the smart vending machine system. In some embodiments, the system includes two or more image capture devices 310 that capture video of products moving in and/or out of the machine to maintain accurate product inventory information. In some embodiments, image capture devices 310 can be placed in areas where products on shelves are seen, such as through a window of the cabinet 304, or when cameras are placed inside the cabinet 304. In such embodiments, before and after images, that is, before a customer removes products and after a customer removes products, of products in the cabinet 304 can be captured. In some embodiments, products cannot be seen when the door of the cabinet 304 is closed, such as if the cameras cannot view through an opaque door of the cabinet. In such embodiments, the image capture devices may attempt to capture images of products in a customer's hands as the customer removes the product(s). In such embodiments, before and after images can be captured during the time in which the cabinet door is opened.

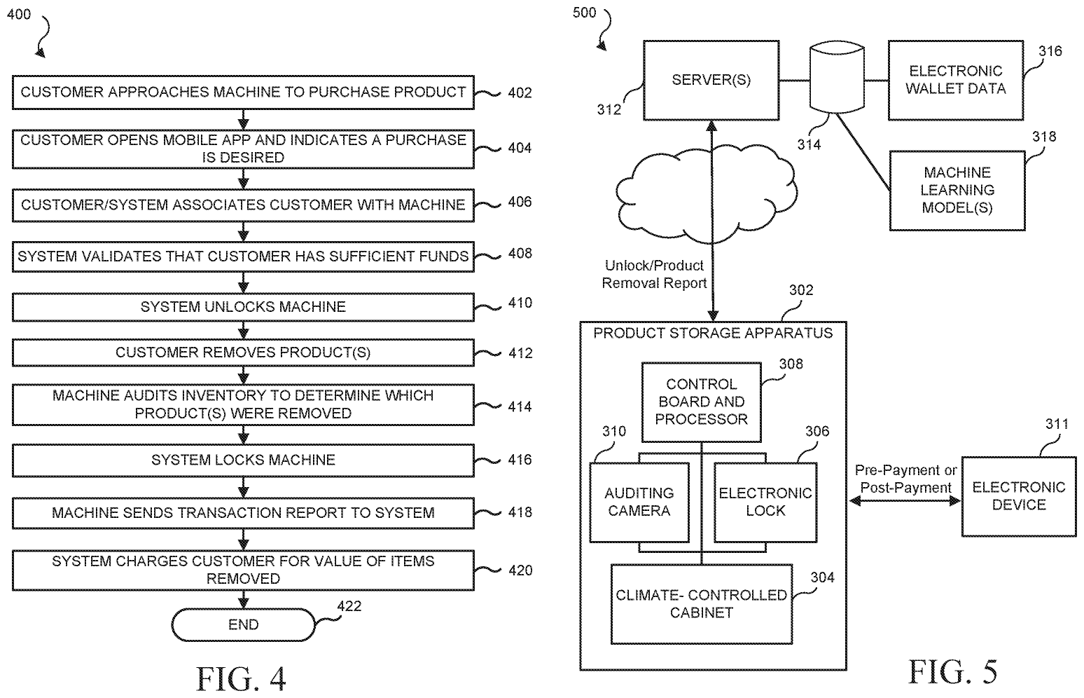

FIG. 4 illustrates an example smart vending machine transaction method 400 in accordance with various embodiments of this disclosure. For ease of explanation, the method 400 is described as involving the use of one or more electronic devices 101 (e.g., the smart vending machine, customer electronic device) and one or more servers, such as server 106, in the network configuration 100 of FIG. 1. However, the method 400 may be used with any other suitable device(s), such as the electronic device 101, and in any other suitable system(s).

At block 402, a customer approaches the smart vending machine to purchase a product. At block 404, the customer opens a mobile application for purchasing products stored within the smart vending machine on the customer's mobile device, and indicates within the mobile application that a purchase of a product is desired. At block 406, the customer and the vending machine perform a process to associate the customer with the particular smart vending machine approached by the customer in block 402. This process can be accomplished in a number of ways.

For example, the customer can scan a barcode printed on the smart vending machine using the mobile application, which causes the mobile application to transmit to the server a customer ID associated with the customer and a smart vending machine ID obtained from scanning the barcode. In some embodiments, the customer scans a machine generated barcode on a display of the smart vending machine using the mobile application. The IDs can be sent either upon scanning the barcode or upon the customer indicating a purchase is desired at block 404. In some embodiments, the image capture device of the smart vending machine scans, using the image recognition system, a barcode displayed in the mobile device application to obtain the customer ID, and then the smart vending machine transmits the customer ID and the smart vending machine ID to the servers, with the purchase being automatically triggered. In some embodiments, the smart vending machine scans, using a bar code reader device, a barcode displayed in the mobile device application to obtain the customer ID, and then the smart vending machine transmits the customer ID and the smart vending machine ID to the servers, with the purchase being automatically triggered. In some embodiments, the mobile application receives BLUETOOTH beacon information broadcast by the smart vending machine, and the customer ID and vending machine ID are sent by the mobile application to the cloud server when the customer indicates a purchase is desired using the mobile application. In some embodiments, the smart vending machine receives BLUETOOTH beacon information broadcast by the mobile application, and the customer ID and vending machine ID are sent by the smart vending machine to the cloud server. In some embodiments, the customer can be identified by the smart vending machine via a card reader included in the smart vending machine that scans an ID card of the customer.

At block 408, the system validates that the customer has sufficient funds for the product indicated by the user using the mobile application. If so, at block 410, the system unlocks the cabinet of the smart vending machine via the electronic lock, such as by transmitting a signal from the cloud server to the smart vending machine to unlock the electronic lock. At block 412, the customer removes product(s) from the vending machine. At block 414, the vending machine audits inventory to determine which product(s) were removed. The inventory auditing can be performed by the image capture device in conjunction with the product auditing and/or image recognition models or algorithms stored in the memory of the smart vending machine, or on the server. For example, one or more images of products within the cabinet can be taken by the image capture device(s) after each transaction, with products being identified in the images. Each time a transaction is completed in which products are added or removed, images are taken and the system, i.e., the smart vending machine or the server, determines using an image recognition model(s) whether new products are added or removed. In some embodiments, a newly captured image can be compared to a previous image to determine which products have been added or removed. In some embodiments, each time an auditing process takes place, the auditing and/or image recognition models newly detect all products within the image. In either case, an inventory is updated for the smart vending machine at the server, in the memory of the smart vending machine, or both. This can in turn update products that are shown as available for purchase within the mobile application. The auditing and/or image recognition models disclosed herein can be machine learning models that are trained to recognize objects such as products within the vending machine. Such machine learning models can include convolutional neural networks (CNNs), such as a deep and/or a region based CNNs, single shot detector (SSD) models, You Only Look Once (YOLO) models, or other image recognition models.

At block 416, the system locks the smart vending machine. In some embodiments, block 416 can be performed before block 414. At block 418, the machine sends a transaction report to the cloud system including the results of the inventory audit. At block 420, the system charges the customer the value for all items removed. In this way, even if the customer removes more products than the customer indicates as desired using the mobile application in block 404, the customer is still charged for any additional items removed by the customer. The process ends at block 422.

Although FIG. 4 illustrates one example of a smart vending machine transaction method 400, various changes may be made to FIG. 4. For example, while shown as a series of steps, various steps in FIG. 4 could overlap, occur in parallel, occur in a different order, or occur any number of times.

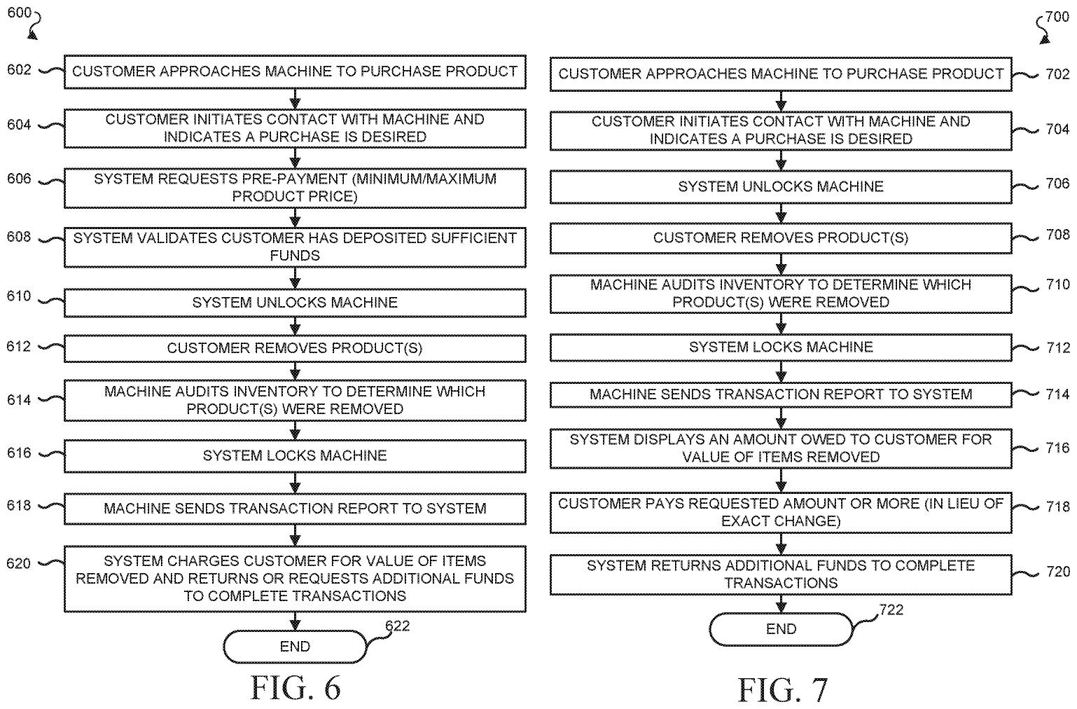

FIG. 5 illustrates an example smart vending machine system 500 in accordance with various embodiments of this disclosure. For ease of explanation, the system 500 is described as involving the use of one or more electronic devices 101 (e.g., vending machine 200) in the network configuration 100 of FIG. 1. However, the system 500 may be used with any other suitable electronic device (such as the server 106) or a combination of devices (such as the electronic device 101 and the server 106) and in any other suitable system(s). Vending machine systems come in a wide variety of configurations, and FIG. 5 does not limit the scope of this disclosure to any particular implementation of a vending machine system. FIG. 5 illustrates a system 500 similar to the system 300 illustrated in FIG. 3. In some embodiments, such as illustrated in FIG. 5, a customer can purchase products while in a pre-payment condition or a post-payment condition, as described with respect to FIGS. 6 and 7, respectively.

FIG. 6 illustrates an example pre-payment transaction method 600 in accordance with various embodiments of this disclosure. For ease of explanation, the method 600 is described as involving the use of one or more electronic devices 101 (e.g., the smart vending machine, customer electronic device) and one or more servers, such as server 106, in the network configuration 100 of FIG. 1. However, the method 600 may be used with any other suitable device(s), such as the electronic device 101, and in any other suitable system(s).

At block 602, a customer approaches the smart vending machine to purchase a product. At block 604, the customer opens a mobile application for purchasing products stored within the smart vending machine on the customer's mobile device, and indicates within the mobile application that a purchase of a product is desired. In some embodiments, the customer can already be associated with the smart vending machine. In some embodiment, the customer and vending matching can be associated during the method 600, such as described with respect to block 406 of FIG. 4.

At block 606, the system requests pre-payment, such as payment in an amount of a minimum or maximum product price. At block 608, the system validates that the customer has deposited sufficient funds. If so, at block 610, the system unlocks the cabinet of the smart vending machine via the electronic lock, such as by transmitting a signal from the cloud server to the smart vending machine to unlock the electronic lock. At block 612, the customer removes product(s) from the vending machine. At block 614, the vending machine audits inventory to determine which product(s) were removed. The inventory auditing can be performed by the image capture device in conjunction with the product auditing and/or image recognition models or algorithms stored in the memory of the smart vending machine, or on the server. For example, one or more images of products within the cabinet can be taken by the image capture device(s) after each transaction, with products being identified in the images. Each time a transaction is completed in which products are added or removed, images are taken and the system, i.e., the smart vending machine or the server, determines using image recognition whether new products are added or removed. In some embodiments, a newly captured image can be compared to a previous image to determine which products have been added or removed. In some embodiments, each time an auditing process takes place, the auditing and/or image recognition models newly detect all products within the image. In either case, an inventory is updated for the smart vending machine, at the server, in the memory of the smart vending machine, or both. This can in turn update products that are shown as available for purchase within the mobile application. The auditing and/or image recognition models disclosed herein can be machine learning models that are trained to recognize objects such as products within the vending machine. Such machine learning models can include convolutional neural networks (CNNs), such as a deep and/or a region based CNNs, single shot detector (SSD) models, You Only Look Once (YOLO) models, or other image recognition models.

At block 616, the system locks the smart vending machine. In some embodiments, block 616 can be performed before block 614. At block 618, the machine sends a transaction report to the cloud system including the results of the inventory audit. At block 620, the system charges the customer the value for all items removed, as well as returning or requesting additional funds to complete the transactions. In this way, even if the customer removes more products than the customer indicates as desired using the mobile application in block 604, the customer is still charged for any additional items removed by the customer if the required amount is higher than the pre-payment amount provided at blocks 606-608. Alternatively, if the amount required is lower than the pre-payment amount provided at blocks 606-608, an amount can be returned to the customer or the customer's account/wallet. The method 600 ends at block 622.

Although FIG. 6 illustrates one example of a pre-payment transaction method 600, various changes may be made to FIG. 6. For example, while shown as a series of steps, various steps in FIG. 6 could overlap, occur in parallel, occur in a different order, or occur any number of times.

FIG. 7 illustrates a post-payment transaction method 700 in accordance with various embodiments of this disclosure. For ease of explanation, the method 700 is described as involving the use of one or more electronic devices 101 (e.g., the smart vending machine, customer electronic device) and one or more servers, such as server 106, in the network configuration 100 of FIG. 1. However, the method 700 may be used with any other suitable device(s), such as the electronic device 101, and in any other suitable system(s).

At block 702, a customer approaches the smart vending machine to purchase a product. At block 704, the customer opens a mobile application for purchasing products stored within the smart vending machine on the customer's mobile device, and indicates within the mobile application that a purchase of a product is desired. In some embodiments, the customer can already be associated with the smart vending machine. In some embodiment, the customer and vending matching can be associated during the method 700, such as described with respect to block 406 of FIG. 4.

At block 706, the system unlocks the cabinet of the smart vending machine via the electronic lock, such as by transmitting a signal from the cloud server to the smart vending machine to unlock the electronic lock. At block 708, the customer removes product(s) from the machine. At block 710, the vending machine audits inventory to determine which product(s) were removed. The inventory auditing can be performed by the image capture device in conjunction with the product auditing and/or image recognition models or algorithms stored in the memory of the smart vending machine, or on the server. For example, one or more images of products within the cabinet can be taken by the image capture device(s) after each transaction, with products being identified in the images. Each time a transaction is completed in which products are added or removed, images are taken and the system, i.e., the smart vending machine or the server, determines using image recognition whether new products are added or removed. In some embodiments, a newly captured image can be compared to a previous image to determine which products have been added or removed. In some embodiments, each time an auditing process takes place, the auditing and/or image recognition models newly detect all products within the image. In either case, an inventory is updated for the smart vending machine, at the server, in the memory of the smart vending machine, or both. This can in turn update products that are shown as available for purchase within the mobile application. The auditing and/or image recognition models disclosed herein can be machine learning models that are trained to recognize objects such as products or the product delivery mechanism within the vending machine. Such machine learning models can include convolutional neural networks (CNNs), such as a deep and/or a region based CNNs, single shot detector (SSD) models, You Only Look Once (YOLO) models, or other image recognition models.

At block 712, the system locks the smart vending machine. In some embodiments, block 712 can be performed before block 710. At block 714, the machine sends a transaction report to the cloud system including the results of the inventory audit. At block 716, the system displays to the customer on a display screen an amount owed for the value of the items removed. At block 718, the customer pays the requested amount (or more in lieu of exact change) using one of the various payment options described in the various embodiments of this disclosure. At block, 720, the system returns any additional paid funds to complete the transactions. Change can be made electronically, such as by adding funds to the customer's electronic wallet, or physically by the vending machine dispensing change in the form of physical currency, if enough change is present. The method 700 ends at block 722.

Although FIG. 7 illustrates one example of a post-payment transaction method 700, various changes may be made to FIG. 7. For example, while shown as a series of steps, various steps in FIG. 7 could overlap, occur in parallel, occur in a different order, or occur any number of times.

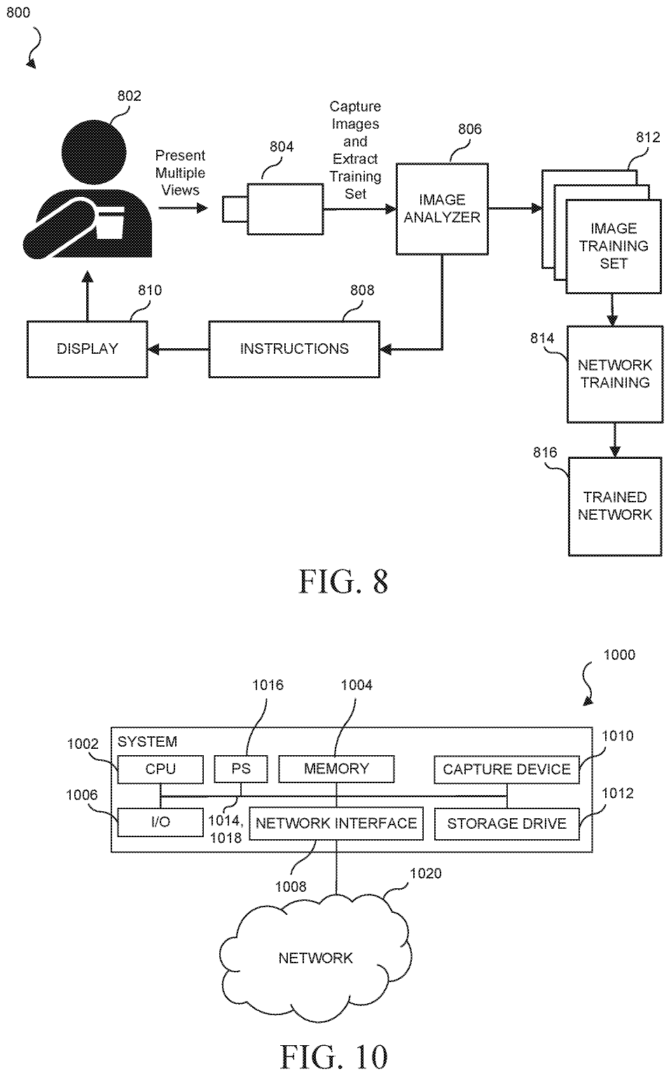

FIG. 8 illustrates an example new product recognition process 800 in accordance with various embodiments of this disclosure. For ease of explanation, the process 800 is described as involving the use of the electronic device 101 (e.g., the smart vending machine) in the network configuration 100 of FIG. 1. However, the process 800 may be used with any other suitable electronic device (such as the server 106) or a combination of devices (such as the electronic device 101 and the server 106) and in any other suitable system(s).

When an operator decides to add a new product to the smart vending machine, the processor can switch the vending machine to a “training mode” that facilitates sampling of the new product images by active interaction with the operator. In some embodiments, the training mode starts with the vending machine inviting the operator to display, such as on a display 810 such as the display 160 or the display 222, a new product in front of the cameras and starts capturing images. As illustrated in FIG. 8, at a step 802, an operator presents multiple views of a product to the one or more image capture devices 804. The operator can hold the product in hand and rotate the product in various directions as the image capture device 804 captures images of the products.

As images are captured by the image capture device 804, an image analyzer 806, executed by a processor of the vending machine, such as the processor 120, communicatively coupled with the image capture device 804, processes the captured images or video. In some embodiments, the image analyzer 806 can extract individual images from video captured by the imaging device 804. In some embodiments, the image analyzer 806 can itself be a machine learning model trained to recognize whether particular product angles are presented or analyze overall image quality of captured images. While capturing images, the vending machine, using the image analyzer 806, provides real time feedback using an active feedback system to the operator on how to manipulate the new product to provide the required view of the object. The active feedback system can include one or more of the image analyzer 806, the display 810, or an indicator such as the indicator 224. For example, the image analyzer 806 can determine if an appropriate level of detail to update the image recognition models has been received. If not, the image analyzer 806 provides feedback to the operator. For example, if more images are required, such as images of different portions of the product, the image analyzer 806 causes a display on the display 810 of the smart vending machine to display instructions and/or requests 808 to the operator to continue rotating the image. The display may also provide the operator with focus-related feedback, such as requests to move the product closer or farther away from the camera 804. In some embodiments, instead of providing messages on a display, the smart vending machine includes an LED that remains red as more images are needed, and switches to green when enough images have been received. In some embodiments, the operator may receive notifications, instructions, or requests on the operator's mobile device, such as over a BLUETOOTH connection with the smart vending machine or over a cellular connection with a remote computer.

Once the vending machine determines the set of images is sufficient or “representative” it notifies the operator that the process is complete, and the vending machine can switch back to a normal operational mode. In some embodiments, the operator can also provide additional product information to be associated in the system with the product, such as a product code, a price for the product, vending machine owner identifiers, or other information. This information can be stored locally in the memory of the vending machine, and/or on the cloud server, in a product library. In some embodiments, before the vending machine switches back to the normal operational mode, it asks if the operator would like to train another object, and, in that case, instead of exiting the training mode it provides an invite for the next training session. In some embodiments, if the vending machine has a network connection, data such as a training set can be uploaded automatically. In some embodiments, the operator can download data to media, e.g., a USB stick, and provide it to the vending machine for new model training.

Once the vending machine has a representative set of images, one or more image recognition models used by the vending machine system to identify products in captured images, either stored on the vending machine or at a server(s), is trained on the new product using an image training set 812 formatted as, for example, a neural training set for input into the model(s). Training of the model(s) is performed at step 814. For example, the images of the neural training set are provided to the machine learning model(s) and, based on one or more outputs from the machine learning model(s), such as an object class provided by the machine learning model(s), the processor determines an error or loss using a loss function and modifies the machine learning model(s) based on the error or loss. The outputs of the machine learning model(s) using the training input data can represent confidences, such as a classification probability for an object (e.g., a prediction that the object is a soft drink product and/or of a particular brand), and the confidences can be provided to a loss function. The loss function calculates the error or loss associated with the machine learning model(s) predictions. For example, when the outputs of the machine learning model(s) differ from known ground truths, the differences can be used to calculate a loss as defined by the loss function. The loss function may use any suitable measure of loss associated with outputs generated by the machine learning model(s), such as a cross-entropy loss or a mean-squared error.

As part of the training process, the processor determines whether the initial training of the machine learning model(s) is complete, such as determining whether the model(s) is providing predictions at an acceptable accuracy level. When the loss calculated by the loss function is larger than desired, the parameters, e.g., weights, of the machine learning model(s) can be adjusted. Once adjusted, the same or additional training input data can be provided to the adjusted model(s), and additional outputs from the model(s) can be compared to the ground truths so that additional losses can be determined using the loss function. Ideally, over time, the model(s) produces more accurate outputs that more closely match the ground truths, and the measured loss becomes less. The amount of training data used can vary depending on the number of training cycles and may include various quantities of training data. At some point, the measured loss can drop below a specified threshold, indicating that training of the machine learning model(s) can be completed.

Once the model(s) is trained on the new data, the model(s) can be updated in the system and stored as a trained model(s) 816. In some embodiments, the model can be stored on the vending machine or on the cloud servers. In some embodiments, the vending machine can build a new model based on captured data by itself, in which case the vending machine could also provide additional functionality to share the new model with other machines by variety of methods. The images and product information could also be used to update product information and image recognition models for other vending machines, even vending machines owned by other customers using the services of the smart vending machine system. In some embodiments, if a network connection is appropriate, the vending machine could stream data directly to an external point that would perform data processing and provide feedback to the vending machine based on the results of that processing. In some embodiments, the image analyzer 806 and other processing can be performed on the smart vending machine, in the cloud, or a combination thereof.

The above process 800 enables operators to quickly add new products by simplifying the new product image generation process, due to the interactive active feedback to the operator during the image generation session and the ability of the vending machine system to analyze in real-time captured images to determine if data is sufficient to build a reliable model.

Although FIG. 8 illustrates one example of a new product recognition process 800, various changes may be made to FIG. 8. For example, although FIG. 8 illustrates the operator holding the product in hand and rotate the product in various directions as the image capture device captures images of the products, in some embodiments, a rotatable platform can be used in which the operator places the product on the rotatable platform and the image capture device captures images of the product on the rotatable platform as the platform rotates either automatically or manually by the operator. The platform can be located inside the cabinet of the smart vending machine in some embodiments.

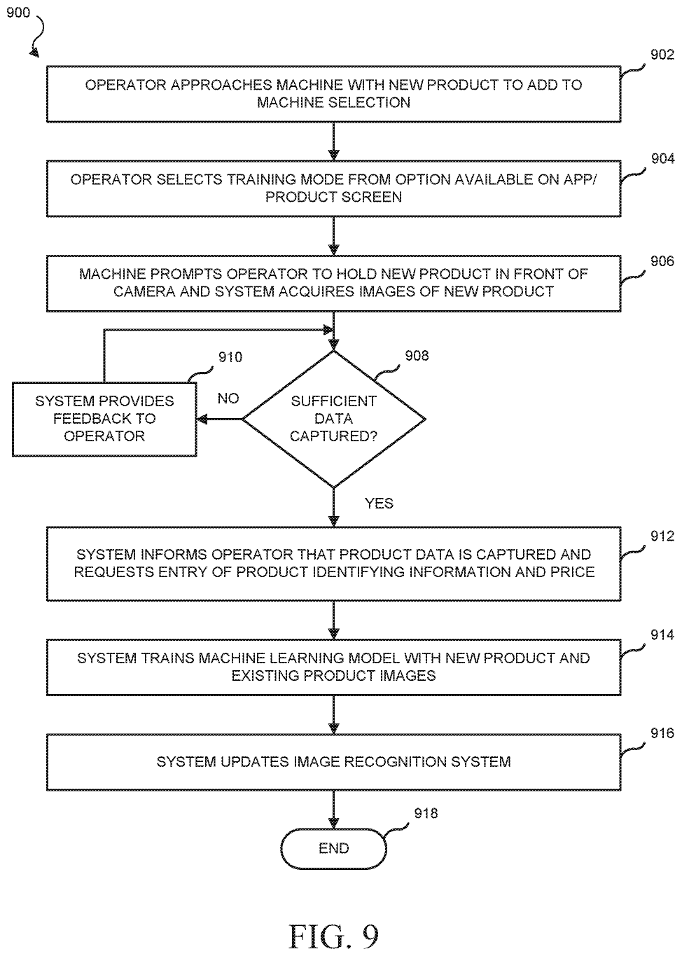

FIG. 9 illustrates a new object recognition method 900 in accordance with various embodiments of this disclosure. For ease of explanation, the method 900 is described as involving the use of one or more electronic devices 101 (e.g., the smart vending machine, customer electronic device) and/or one or more servers, such as server 106, in the network configuration 100 of FIG. 1. However, the method 900 may be used with any other suitable device(s), such as the electronic device 101, and in any other suitable system(s).

At block 902, an operator approaches a smart vending machine with a new product to add to the machine's product selection. At block 904, the operator selects a training mode option available on a screen displayed by a display of the vending machine. At block 906, the vending machine prompts the operator to present the product in front of at least one image capture device and the system acquires images of the new product. At decision block 908, the system/processor determines if sufficient data has been captured for the new product to update the machine learning models used by the system. If not, the method 900 moves to block 910.

At block 910, the system provides feedback to the operator, such as feedback to continue rotating the product, feedback to move the product farther away or closer to the image capture device, or other feedback. The method 900 then loops back to decision block 908. For example, if the image captured does not meet a quality threshold, is taken at an angle that inhibits object detection, etc., the processor of the device in receipt of the image, such as the vending machine or the server, can provide a feedback loop in which an instruction is provided to attempt further image capture. This feedback loop can continue, with the method 900 looping from decision block 908 back to block 910, until no feedback, or positive feedback, is provided, at which point, the method 900 moves to block 912.

At block 912, the system informs the operator that sufficient or representative product data has been captured, and requests entry of additional information such as product identifying information (product code), price, or other information. At block 914, the system uses the representative product data set as a training set to train the machine learning and image recognition model with the product images, as well as existing product images of other products in the system. Training of the image recognition model can include providing the representative product data set to image recognition model and, based on one or more outputs from the image recognition model, such as an object class provided by the image recognition model, the processor determines an error or loss using a loss function and modifies the image recognition model based on the error or loss. The outputs of the image recognition model using the training input data can represent confidences, such as a classification probability for an object (e.g., a prediction that the object is a soft drink product and/or of a particular brand), and the confidences can be provided by the processor to a loss function. The loss function calculates the error or loss associated with the image recognition model predictions. For example, when the outputs of the image recognition model differ from known ground truths, the differences can be used to calculate a loss as defined by the loss function. The loss function may use any suitable measure of loss associated with outputs generated by the image recognition model, such as a cross-entropy loss or a mean-squared error.

As part of the training process, the processor determines whether the initial training of the image recognition model is complete, such as determining whether the image recognition model is providing predictions at an acceptable accuracy level. When the loss calculated by the loss function is larger than desired, the parameters, e.g., weights, of the image recognition model can be adjusted. Once adjusted, the same or additional training input data can be provided to the adjusted image recognition model, and additional outputs from the image recognition model can be compared to the ground truths so that additional losses can be determined using the loss function. Ideally, over time, the image recognition model produces more accurate outputs that more closely match the ground truths, and the measured loss becomes less. The amount of training data used can vary depending on the number of training cycles and may include various quantities of training data. At some point, the measured loss can drop below a specified threshold, indicating that training of the image recognition model can be completed. At block 916, the system updates the image recognition model(s) on the system for use in subsequent product image recognition tasks. The method 900 ends at block 918.

FIG. 10 illustrates another example electronic device 1000 in accordance with various embodiments of this disclosure. The device 1000 can be one example of a portion of the smart vending machine system, such as the vending machine, a server of the one or more cloud servers, or the mobile device, as illustrated for example in FIGS. 2, 3, and 5, or other devices. The device 1000 can include a controller (e.g., a processor/central processing unit (“CPU”)) 1002, a memory unit 1004, and an input/output (“I/O”) device 1006. The device 1000 also includes at least one network interface 1008, or network interface controllers (NICs). The device 1000 can further includes at least one capture device 1010 for capturing media or inputs to the system through an I/O device. In some embodiments, the capture device 1010 can be the image capture device illustrated in FIGS. 3 and 5. In some embodiments, the capture device is not included. The device 1000 also includes a storage drive 1012 used for storing content such as PIN inputs. The components 1002, 1004, 1006, 1008, 1010, and 1012 are interconnected by a data transport system (e.g., a bus) 1014. A power supply unit (PSU) 1016 provides power to components of the system 1000 via a power transport system 1018 (shown with data transport system 1014, although the power and data transport systems may be separate).

It is understood that the system 1000 may be differently configured and that each of the listed components may actually represent several different components. For example, the CPU 1002 may actually represent a multi-processor or a distributed processing system; the memory unit 1004 may include different levels of cache memory, and main memory; the I/O device 1006 may include monitors, keyboards, touchscreens, and the like; the at least one network interface 1008 may include one or more network cards providing one or more wired and/or wireless connections to a network 1020; and the storage drive 1012 may include hard disks and remote storage locations. Therefore, a wide range of flexibility is anticipated in the configuration of the system 1000, which may range from a single physical platform configured primarily for a single user or autonomous operation to a distributed multi-user platform such as a cloud computing system.

The system 1000 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 1000. The operating system, as well as other instructions (e.g., for telecommunications and/or other functions provided by the device 1000), may be stored in the memory unit 1004 and executed by the processor 1002. The memory unit 1004 may include instructions for performing some or all of the steps, process, and methods described herein, and can include product information such as product codes and prices, and/or the product recognition models or algorithms in the various embodiments of this disclosure.

The network 1020 may be a single network or may represent multiple networks, including networks of different types, whether wireless or wired. For example, the device 1000 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 1000 with external devices.

In one example embodiment, a vending machine uses a representative product data set as a training set to train the machine learning and image recognition model with the product images, as well as existing product images of other products in the vending machine. The vending machine updates the image recognition model(s) on the local vending machine for use in subsequent product image recognition tasks. The vending machine sends the product images to a remote computer that uses representative product data set as a training set to training the machine learning and image recognition model with the product images, as well as existing product images of other products in the vending machine to create a global product recognition model that can be employed to more than one vending machines. In some embodiments, a product added by a vending machine operator in one machine can be added to other vending machines owned by the same operator. In some embodiments, a product added by a vending machine operator can be added by another vending machine operator.

In another example embodiment, a method of adding a new product into a camera-based vending machine includes entering by an operator the camera-based vending machine into new product addition mode, holding by the operator the new product in at least one of her/his hands, presenting by the operator the new product in front of a camera in the camera-based vending machine, taking, by the camera, a picture of the new product held by the operator in at least one of her/his hands, providing feedback to the operator to take a next picture of the new product in a different view to complete the training set of images for the new product, indicating to the operator that sufficient views of the new product have been gathered, updating a product recognition algorithm to recognize the new product, and adding the new product into the camera-based vending machine.

In one or more of the above examples, the product recognition algorithm is updated to recognize the new product after a pre-determined delay.

In one or more of the above examples, the product recognition algorithm is updated in a remote computer.

In one or more of the above examples, the product recognition algorithm is updated in a local computer.

In one or more of the above examples, feedback to operator is provided by a screen.

In one or more of the above examples, feedback to operator is provided by a LED.

In another example embodiment, a new product onboarding system for a camera-based vending machine without a dispensing system comprises an enclosed space with space to store products inside the camera-based vending machine without a dispensing system, at least a camera to take multiple pictures of product taken out by a customer, a processing unit to identify products from at least a picture, the camera to capture images of a new product to be added to the camera-based vending machine without a dispensing system where the product is held in an operator's hand, an active feedback system to instruct the operator to present different views of the new product held in operator's hand, the active feedback system to inform the operator that sufficient views of the new product have been gathered, and the processing unit to update a product recognition algorithm to recognize the new product.

In one or more of the above examples, the product recognition algorithm is updated to recognize the new product after a pre-determined delay.

In one or more of the above examples, the processing unit to update the product recognition algorithm is located remotely.

In one or more of the above examples, the processing unit to update the product recognition algorithm is located in a local computer.

In one or more of the above examples, a screen provides feedback to operator.

In one or more of the above examples, a LED provides feedback to operator.

In another example embodiment, a method of adding a new product into a camera-based vending machine comprises entering by an operator the camera-based vending machine into new product addition mode, placing by the operator the new product in a new product add location in the camera-based vending machine, taking, by the camera, a picture of the new product placed in the new product add location by the operator, providing feedback to the operator to take a next picture of the new product in a different view to complete the training set of images for the new product, indicating to the operator that sufficient views of the new product have been gathered, updating a product recognition algorithm to recognize the new product, and adding the new product into the camera-based vending machine.

In one or more of the above examples, the product recognition algorithm is updated to recognize the new product after a pre-determined delay.

In one or more of the above examples, the product recognition algorithm is updated in a remote computer.

In one or more of the above examples, the product recognition algorithm is updated in a local computer.

In one or more of the above examples, feedback to operator is provided by a screen.

In one or more of the above examples, feedback to operator is provided by a LED.

In another example embodiment, a new product onboarding system for a camera-based vending machine without a dispensing system comprises an enclosed space with space to store products inside the camera-based vending machine without a dispensing system, at least a camera to take multiple pictures of product taken out by a customer, a processing unit to identify products from at least a picture, the camera to capture images of a new product to be added to the camera-based vending machine without a dispensing system where the product is placed in a new product add location in the camera-based vending machine, an active feedback system to instruct the operator to present different views of the new product placed in the new product add location in the camera-based vending machine, the active feedback system to inform the operator that sufficient views of the new product have been gathered, and the processing unit to update a product recognition algorithm to recognize the new product.

In one or more of the above examples, the product recognition algorithm is updated to recognize the new product after a pre-determined delay.

In one or more of the above examples, the processing unit to update the product recognition algorithm is located remotely.

In one or more of the above examples, the processing unit to update the product recognition algorithm is located in a local computer.

In one or more of the above examples, a screen provides feedback to operator.

In one or more of the above examples, a LED provides feedback to operator.

In another example embodiment, a method comprises switching, by at least one processor of a system associated with a vending machine in response to an input, the vending machine from an operational mode to a training mode, detecting, by the at least one processor using at least one imaging sensor, an object within view of the at least one imaging sensor, capturing, using the at least one imaging sensor, one or more images of the object, providing, by the at least one processor, feedback based on the one or more captured images of the object regarding a different view to be included in a training set of images for the object, capturing, using the at least one imaging sensor, at least one next image of the object in the different view, generating, by the at least one processor based on a determination that sufficient views of the object have been captured, the training set of images from at least a portion of the captured images, and training, by the at least one processor, a machine learning model using the training set of images to update the machine learning model to recognize the object.

In one or more of the above examples, the object is a new product to be added to the vending machine, and the method further comprises adding information on the new product to the system associated with the vending machine.

In one or more of the above examples, the method further comprises receiving product identifying information and pricing information on the new product and updating the system associated with the vending machine by associating the product identifying information and pricing information with the new product.

In one or more of the above examples, the machine learning model is a product recognition model configured to recognize products included in the vending machine.

In one or more of the above examples, during the detecting of the object and the capturing of the one or more images of the object, the object is held by an operator of the vending machine or by a rotatable platform of the vending machine.

In one or more of the above examples, the vending machine does not include an automated dispensing system.

In one or more of the above examples, the vending machine includes a door with an electronic lock, and the method further comprises receiving, by the at least one processor and when in the operational mode, an unlock command in response to a payment authorization.

In one or more of the above examples, the machine learning model is updated to recognize the object after a pre-determined delay.

In one or more of the above examples, the machine learning model is updated in either a local electronic device or a remote electronic device.

In one or more of the above examples, providing the feedback includes at least one of displaying the feedback on a screen and displaying one or more colors using an LED of the vending machine.

In another example embodiment, a system comprises at least one processor, at least one memory coupled to the at least one processor, a vending machine associated with the at least one processor, the vending machine including a cabinet to store objects, at least one imaging sensor coupled to the vending machine, and an active feedback system coupled to the vending machine. The at least one processor is configured to switch, in response to an input, the vending machine from an operational mode to a training mode, detect, using the at least one imaging sensor, an object within view of the at least one imaging sensor, capture, using the at least one imaging sensor, one or more images of the object, provide, using the active feedback system, feedback based on the one or more captured images of the object regarding a different view to be included in a training set of images for the object, capture, using the at least one imaging sensor, at least one next image of the object in the different view, generate, based on a determination that sufficient views of the object have been captured, the training set of images from at least a portion of the captured images, and train a machine learning model using the training set of images to update the machine learning model to recognize the object.

In one or more of the above examples, the object is a new product to be added to the vending machine, and the at least one processor is further configured to add information on the new product to the at least one memory.

In one or more of the above examples, the at least one processor is further configured to receive product identifying information and pricing information on the new product and update the at least one memory by associating the product identifying information and pricing information with the new product.

In one or more of the above examples, the machine learning model is a product recognition model configured to recognize products included in the vending machine.

In one or more of the above examples, during the detection of the object and the capture of the one or more images of the object, the object is held by an operator of the vending machine or by a rotatable platform of the vending machine.

In one or more of the above examples, the vending machine does not include an automated dispensing system.

In one or more of the above examples, the vending machine includes a door with an electronic lock, and the at least one processor is further configured to receive, by the at least one processor and when in the operational mode, an unlock command in response to a payment authorization.

In one or more of the above examples, the machine learning model is updated to recognize the object after a pre-determined delay.

In one or more of the above examples, the machine learning model is updated in either a local electronic device or a remote electronic device.

In one or more of the above examples, to provide the feedback, the at least one processor is further configured to instruct at least one of display the feedback on a screen and display one or more colors using an LED of the vending machine.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method comprising:
switching, by at least one processor of a system associated with a vending machine in response to an input, the vending machine from an operational mode to a training mode;
detecting, by the at least one processor using at least one imaging sensor, an object within view of the at least one imaging sensor;
capturing, using the at least one imaging sensor, one or more images of the object;
providing, by the at least one processor, feedback based on the captured one or more images of the object regarding a different view to be included in a training set of images for the object;
capturing, using the at least one imaging sensor, at least one next image of the object in the different view;
generating, by the at least one processor based on a determination that sufficient views of the object have been captured, the training set of images from at least a portion of the captured one or more images of the object; and
training, by the at least one processor, a machine learning model using the training set of images to update the machine learning model to recognize the object.

2. The method of claim 1, wherein the object is a new product to be added to the vending machine, the method further comprising:
adding information on the new product to the system associated with the vending machine.

3. The method of claim 2, further comprising:
receiving product identifying information and pricing information on the new product; and
updating the system associated with the vending machine by associating the product identifying information and pricing information with the new product.

4. The method of claim 2, wherein the machine learning model is a product recognition model configured to recognize products included in the vending machine.

5. The method of claim 1, wherein, during the detecting of the object and the capturing of the one or more images of the object, the object is held by an operator of the vending machine or by a rotatable platform of the vending machine.

6. The method of claim 1, wherein the vending machine does not include an automated dispensing system.

7. The method of claim 6, wherein the vending machine includes a door with an electronic lock, the method further comprising:
receiving, by the at least one processor and when in the operational mode, an unlock command in response to a payment authorization.

8. The method of claim 1, wherein the machine learning model is updated to recognize the object after a pre-determined delay.

9. The method of claim 1, wherein the machine learning model is updated in either a local electronic device or a remote electronic device.

10. The method of claim 1, wherein providing the feedback includes at least one of:
displaying the feedback on a screen; and
displaying one or more colors using an LED of the vending machine.

11. A system comprising:
at least one processor;
at least one memory coupled to the at least one processor;
a vending machine associated with the at least one processor, the vending machine including a cabinet to store objects;
at least one imaging sensor coupled to the vending machine; and
an active feedback system coupled to the vending machine,
wherein the at least one processor is configured to:
switch, in response to an input, the vending machine from an operational mode to a training mode;
detect, using the at least one imaging sensor, an object within view of the at least one imaging sensor;
capture, using the at least one imaging sensor, one or more images of the object;
provide, using the active feedback system, feedback based on the captured one or more images of the object regarding a different view to be included in a training set of images for the object;
capture, using the at least one imaging sensor, at least one next image of the object in the different view;
generate, based on a determination that sufficient views of the object have been captured, the training set of images from at least a portion of the captured one or more images of the object; and
train a machine learning model using the training set of images to update the machine learning model to recognize the object.

12. The system of claim 11, wherein the object is a new product to be added to the vending machine, and
wherein the at least one processor is further configured to add information on the new product to the at least one memory.

13. The system of claim 12, wherein the at least one processor is further configured to:
receive product identifying information and pricing information on the new product; and
update the at least one memory by associating the product identifying information and pricing information with the new product.

14. The system of claim 12, wherein the machine learning model is a product recognition model configured to recognize products included in the vending machine.

15. The system of claim 11, wherein, during the detection of the object and the capture of the one or more images of the object, the object is held by an operator of the vending machine or by a rotatable platform of the vending machine.

16. The system of claim 11, wherein the vending machine does not include an automated dispensing system.

17. The system of claim 16, wherein the vending machine includes a door with an electronic lock, and
wherein the at least one processor is further configured to receive, by the at least one processor and when in the operational mode, an unlock command in response to a payment authorization.

18. The system of claim 11, wherein the machine learning model is updated to recognize the object after a pre-determined delay.

19. The system of claim 11, wherein the machine learning model is updated in either a local electronic device or a remote electronic device.

20. The system of claim 11, wherein to provide the feedback, the at least one processor is further configured to instruct at least one of:
display the feedback on a screen; and
display one or more colors using an LED of the vending machine.
